(19) United States
(12) Patent Application Publication
(10) Pub. No.: US 2010/0214071 A1
(43) Pub. Date: Aug. 26, 2010

(54) RFID TAG COMMUNICATING APPARATUS AND RFID TAG COMMUNICATION SYSTEM

(75) Inventors: Takuya Nagai, Nagoya-shi (JP); Kazunari Taki, Nagoya-shi (JP); Hidehisa Shiomi, Nara-shi (JP)

Correspondence Address: DAY PITNEY LLP, 7 TIMES SQUARE, NEW YORK, NY, 10036-7311, US

(73) Assignee: BROTHER KOGYO KABUSHIKI KAISHA, Nagoya-shi (JP)

(21) Appl. No.: 12/775,613

(22) Filed: May 7, 2010

Related U.S. Application Data
(63) Continuation-in-part of application No. PCT/JP2008/068311, filed on Oct. 8, 2008.

(30) Foreign Application Priority Data
Nov. 9, 2007 (JP) 2007-292626

(51) Int. Cl. H04Q 5/22

(52) U.S. Cl. 340/10.1

(57) ABSTRACT

An RFID tag communicating apparatus transmitting a transmission signal to a predetermined RFID tag and receiving a return signal returned from the RFID tag with a plurality of antennas to communicate information with the RFID tag, includes a received signal processing portion that separates return signals from a plurality of RFID tags included in received signals based on the received signals received with the plurality of the antennas correspondingly to a first communication in accordance with a predefined relationship; and an information communication control portion that performs a second communication continued from the first communication with at least one RFID tag of a plurality of the RFID tags corresponding to the return signals separated by the received signal processing portion.

### CROSS REFERENCE TO RELATED APPLICATION

The present application is a Continuation-in-Part of International Application No. PCT/JP2008/068311 filed Oct. 8, 2008, which claims the benefits of Japanese Patent Application No. 2007-292626 filed Nov. 9, 2007, the disclosure of which is herein incorporated by reference in its entirety.

### TECHNICAL FIELD

The present invention relates to an RFID tag communicating apparatus and an RFID tag communication system performing communication with an RFID tag capable of wirelessly writing and reading information and, particularly, to improvement for communicating information with a plurality of RFID tags in parallel.

### BACKGROUND ART

An RFID (Radio Frequency Identification) system is known that reads information without contact with a predetermined RFID tag communicating apparatus (interrogator) from a small RFID tag (responder) storing predetermined information. Since even if an RFID tag is contaminated or disposed at blind spot, information stored in the RFID tag is readable through communication with an RFID tag communicating apparatus, the RFID system is expected to be practically used in various fields such as commodity management and inspection operation.

The RFID tag communication system that communicates information among a plurality of RFID tags and the RFID tag communicating apparatus has a defect that information becomes unreadable due to crosstalk occurring in the RFID tag communicating apparatus since the responses from a plurality of the RFID tags are generated in parallel (at the same time). Therefore, techniques are proposed for resolving the defect. For example, for an RFID tag communicating apparatus (interrogator) that includes a communication request signal generating portion that generates a plurality of communication request signals and an intercommunication determining portion that selects a communicatable RFID tag in accordance with a response request among a plurality of RFID tags (responders) which receive in a plurality of time slots synchronized with communication start request signals generated by the communication request signal generating portion, a technique has been proposed to vary the number of the time slots with the intercommunication determining portion in accordance with the number of RFID tags within an intercommunication area. It is considered that reliable communication operation with a plurality of RFID tags is achievable with this technique.

### DISCLOSURE OF THE INVENTION

### Problems to be Solved by the Invention

However, the conventional technique requires relatively long time for communication between an interrogator and RFID tags to select an RFID tag communicatable with the interrogator and has an adverse effect that the occurrence of crosstalk is not sufficiently prevented. Since the interrogation wave transmitted from the RFID tag communicating apparatus generally has the same frequency as the response waves of RFID tags and the response waves from a plurality of RFID tags is unable to be separated by frequency and an effective separating method does not exist, a problem may occur such as being unable to read the response wave of the RFID tag. Therefore, it is required to develop an RFID tag communicating apparatus and an RFID tag communication system capable of communicating information with a plurality of RFID tags in parallel.

The present invention was conceived in view of the background and it is therefore the object of the present invention to provide an RFID tag communicating apparatus and an RFID tag communication system capable of communicating information with a plurality of RFID tags in parallel.

### Means for Solving the Problems

The object indicated above is achieved in the first mode of the present invention, which provides an RFID tag communicating apparatus transmitting a transmission signal to a predetermined RFID tag and receiving a return signal returned from the RFID tag with a plurality of antennas to communicate information with the RFID tag, including: a received signal processing portion that separates return signals from a plurality of RFID tags included in received signals based on the received signals received with the plurality of the antennas correspondingly to a first communication in accordance with a predefined relationship; and an information communication control portion that performs a second communication continued from the first communication with at least one RFID tag of a plurality of the RFID tags corresponding to the return signals separated by the received signal processing portion.

The object indicated above is achieved in the second mode of the present invention, which provides an RFID tag communication system communicating information among a plurality of RFID tags and the RFID tag communicating apparatus of the first mode of the present invention.

According to the first mode of the invention, the apparatus includes a received signal processing portion that separates return signals from a plurality of RFID tags included in received signals based on the received signals received with the plurality of the antennas correspondingly to a first communication in accordance with a predefined relationship, and an information communication control portion that performs a second communication continued from the first communication with at least one RFID tag of a plurality of the RFID tags corresponding to the return signals separated by the received signal processing portion. Consequently, even if a plurality of the RFID tags makes responses in parallel in the first communication, the information communication may be continued in a preferable manner with a plurality of the RFID tags in the second communication continued from the first communication. The RFID tag communicating apparatus may be provided that may perform the information communication in parallel with a plurality of the RFID tags.

Preferably, in the first mode of the invention, the received signal processing portion evaluates independency of a plurality of received signal components at least partially overlapping in both a frequency domain and a time domain to separate return signals from a plurality of RFID tags included in the received signals based on the evaluation result. Consequently, the received signal having a mixture of the return signals from a plurality of the RFID tags at least partially overlapping in both the frequency domain and the time domain may be separated into the components.

Preferably, the information communication control portion performs the second communication with any single RFID tag of a plurality of the RFID tags corresponding to the return signals separated by the received signal processing portion. Consequently, if the responses from a plurality of the RFID tags are made in parallel in the first communication, the information communication may be continued with any one RFID tag of a plurality of the RFID tags in the second communication continued from the first communication to prevent the occurrence of crosstalk in a preferable manner.

Preferably, the apparatus includes a signal intensity detecting portion that detects signal intensities of the return signals separated by the received signal processing portion, wherein the information communication control portion performs the second communication with any single RFID tag selected based on the signal intensities detected by the signal intensity detecting portion from a plurality of the RFID tags corresponding to the return signals separated by the received signal processing portion. Consequently, if the responses from a plurality of the RFID tags are made in parallel in the first communication, the information communication may be continued with any one RFID tag selected based on the signal intensity among a plurality of the RFID tags in the second communication continued from the first communication to prevent the occurrence of crosstalk in a preferable manner.

Preferably, the apparatus includes an SN ratio detecting portion that detects SN ratios of the return signals separated by the received signal processing portion, wherein the information communication control portion performs the second communication with any single RFID tag selected based on the SN ratios detected by the SN ratio detecting portion from a plurality of the RFID tags corresponding to the return signals separated by the received signal processing portion. Consequently, if the responses from a plurality of the RFID tags are made in parallel in the first communication, the information communication may be continued with any one RFID tag selected based on the SN ratio among a plurality of the RFID tags in the second communication continued from the first communication to prevent the occurrence of crosstalk in a preferable manner.

Preferably, the information communication control portion sequentially performs the second communication with a plurality of the RFID tags corresponding to the return signals separated by the received signal processing portion. Consequently, even if a plurality of the RFID tags makes responses in parallel in the first communication, the information communication may sequentially be continued with a plurality of the RFID tags in the second communication continued from the first communication.

Preferably, when the second communication is sequentially performed with a plurality of the RFID tags corresponding to the return signals separated by the received signal processing portion, the information communication control portion transmits a transmission signal to another RFID tag while receiving a return signal from a predetermined RFID tag. Consequently, even if a plurality of the RFID tags makes responses in parallel in the first communication, the information communication may sequentially and expeditiously be continued in a short period of time with a plurality of the RFID tags in the second communication continued from the first communication.

Preferably, the information communication control portion performs the second communication at the same time with a plurality of the RFID tags corresponding to the return signals separated by the received signal processing portion and wherein based on received signals received by the plurality of the antennas correspondingly to the second communication, the received signal processing portion separates return signals from a plurality of the RFID tags included in the received signals. Consequently, even if a plurality of the RFID tags makes responses in parallel in the first communication, the information communication may be continued at the same time with a plurality of the RFID tags in the second communication continued from the first communication.

At the time of process of separating the return signals from a plurality of the RFID tags included in the received signals received by the plurality of the antennas correspondingly to the second communication, the received signal processing portion utilizes a calculation result of a process of separating the return signals from a plurality of the RFID tags included in the received signals received by the plurality of the antennas correspondingly to the first communication. Consequently, if the information communication is continued at the same time with a plurality of the RFID tags in the second communication continued from the first communication, the received signals corresponding to the second communication may expeditiously be separated in a short period of time into the return signals from the RFID tags.

Preferably, the received signal processing portion whitens the received signals received by the plurality of the antennas correspondingly to the first communication and normalizes and orthogonalizes a restoring matrix determined based on the whitened signals to separate the return signals from a plurality of the RFID tags as independent components included in the received signals. Consequently, the return signals from a plurality of the RFID tags included in the received signals received by the plurality of the antennas may be separated in a practical aspect.

According to the second mode of the invention, an RFID tag communication system communicates information among a plurality of RFID tags and the RFID tag communicating apparatus of the first mode of the invention. Consequently, even if a plurality of the RFID tags makes responses in parallel in the first communication, the information communication may be continued in a preferable manner with a plurality of the RFID tags in the second communication continued from the first communication. The RFID tag communication system may be provided that may perform the information communication in parallel with a plurality of the RFID tags.

Preferably, in the second mode of the invention, if a predetermined command is received from the RFID tag communicating apparatus, the RFID tag halts communication with the RFID tag communicating apparatus until another predetermined command is newly received. Consequently, crosstalk may be prevented in a preferable manner from occurring due to the responses from a plurality of the RFID tags made in parallel.

Preferably, the RFID tag communicating apparatus communicates in parallel with the RFID tags up to number same as antennas included in the RFID tag communicating apparatus. Consequently, the return signals from a plurality of the RFID tags included in the received signals received by the plurality of the antennas may be separated in a preferable manner by the received signal processing portion and the information communication may be performed in parallel with the largest number of the RFID tags.

Preferably, the RFID tag communicating apparatus communicates in parallel with the RFID tags up to number reduced by one from number of antennas included in the RFID tag communicating apparatus. Consequently, the return signals from a plurality of the RFID tags included in the received signals received by the plurality of the antennas may be separated in a preferable manner by the received signal processing portion, and the information communication may be performed in parallel with a plurality of the RFID tags.

### BRIEF DESCRIPTION OF DRAWINGS

FIG. 1 is a diagram for explaining an RFID tag communication system according to one embodiment of a second aspect of the present invention.

FIG. 2 is a diagram for explaining an RFID tag communicating apparatus according to one embodiment of a first aspect of the present invention.

FIG. 3 is a diagram for explaining a configuration of an RFID tag circuit element included in an RFID tag that is a communication object of the RFID tag communicating apparatus of FIG. 2.

FIG. 4 is a diagram for explaining a basic ICA model that is a reference of signal separation by the RFID tag communicating apparatus of FIG. 2.

FIG. 5 is a diagram for explaining an example of a process in the communication with a plurality of RFID tags in a conventional technique when no overlap occurs in the time domain between responses from the RFID tags.

FIG. 6 is a diagram for explaining an example of a process in the communication with a plurality of RFID tags in the conventional technique when the responses from the RFID tags overlap in both the frequency domain and the time domain.

FIG. 7 is a flowchart for explaining an example of RFD) tag communication control by DSP of the RFID tag communicating apparatus of FIG. 2.

FIG. 8 is a flowchart for explaining an example of tag enumeration control in the RFID tag communication control depicted in FIG. 7 in the conventional technology.

FIG. 9 is a flowchart for explaining an example of response control executed by a control portion of the RFID tag circuit element of FIG. 3 in accordance with a transmission signal transmitted from the RFID tag communicating apparatus of FIG. 2.

FIG. 10 is a diagram for explaining an example of a process in the communication with a plurality of RFID tags by the RFID tag communicating apparatus of FIG. 2 when the responses from the RFID tags overlap in both the frequency domain and the time domain.

FIG. 11 is a flowchart for explaining an example of the tag enumeration control in the RFID tag communication control depicted in FIG. 7 by the DSP of the RFID tag communicating apparatus of FIG. 2, corresponding to the process of FIG. 10.

FIG. 12 is a diagram for explaining another example of a process in the communication with a plurality of RFID tags by the RFID tag communicating apparatus of FIG. 2 when the responses from the RFID tags overlap in both the frequency domain and the time domain.

FIG. 13 is a flowchart for explaining another example of the tag enumeration control in the RFID tag communication control depicted in FIG. 7 by the DSP of the RFID tag communicating apparatus of FIG. 2, corresponding to the process of FIG. 12.

FIG. 14 is a diagram for explaining yet another example of a process in the communication with a plurality of RFID tags by the RFID tag communicating apparatus of FIG. 2 when the responses from the RFID tags overlap in both the frequency domain and the time domain.

FIG. 15 is a flowchart for explaining yet another of the tag enumeration control in the RFID tag communication control depicted in FIG. 7 by the DSP of the RFID tag communicating apparatus of FIG. 2, corresponding to the process of FIG. 14.

FIG. 16 is a diagram for explaining a further example of a process in the communication with a plurality of RFID tags by the RFID tag communicating apparatus of FIG. 2 when the responses from the RFID tags overlap in both the frequency domain and the time domain.

FIG. 17 is a flowchart for explaining a further example of the tag enumeration control in the RFID tag communication control depicted in FIG. 7 by the DSP of the RFID tag communicating apparatus of FIG. 2, corresponding to the process of FIG. 16.

### EXPLANATIONS OF LETTERS OR NUMERALS

10: RFID tag communication system, 12: RFID tag communicating apparatus, 14: RFID tag, 16: DSP, 18: antenna, 20: transmitting/receiving circuit, 22: carrier wave output portion, 24: transmission data multiplying portion, 26: transmission amplifying portion, 28: transmission/reception separating portion, 30: filter, 32: cancel phase sifting portion, 34: cancel amplifying portion, 36: cancel combining portion, 38: demodulating portion, 40: reception amplifying portion, 42: reception filter, 44: reception A/D converting portion, 50: information communication control portion, 52: transmission data generating portion, 54: received signal processing portion, 58: weight calculating portion, 60: signal separating portion, 62: signal intensity detecting portion, 64: SN ratio detecting portion, 66: memory portion, 70: RFID tag circuit element, 72: antenna portion, 74: IC circuit portion, 76: rectifying portion, 78: power source portion, 80: clock extracting portion, 82: memory portion, 84: modulating/demodulating portion, 86: control portion

### BEST MODES FOR CARRYING OUT THE INVENTION

Preferred embodiments of the present invention will now be described with reference to the drawings.

### Embodiments

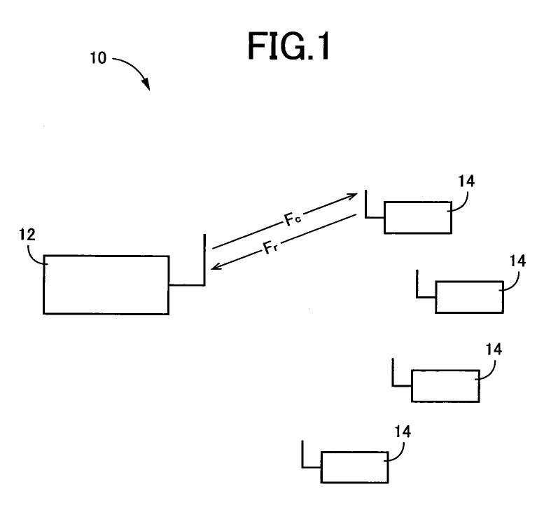

An RFID tag communication system 10 of FIG. 1 is a so-called RFID (Radio Frequency Identification) system made up of an RFID tag communicating apparatus 12 that is an embodiment of a first aspect of the present invention and one or a plurality of (in FIG. 1, four) RFID tags 14 that are communication objects of the RFID tag communicating apparatus, and the RFID tag communicating apparatus 12 and the RFID tags 14 act as an interrogator and responders, respectively, of the RFID tag communicating apparatus 12. When the RFID tag communicating apparatus 12 transmits an interrogation wave F, (transmission signal) to the RFID tags 14, the interrogation wave F_{c} is modulated with a predetermined information signal (data) and returned as a response wave Fᵣ (return signal) by the RFID tag 14 receiving the interrogation wave F_{c} to communicate information between the RFID tag communicating apparatus 12 and the RFID tag 14. The RFID tag communication system 10 is used for management of goods within a predetermined communication area, for example, and the RFID tags 14 are preferably integrally provided on the goods by affixing to the goods to be managed, etc.

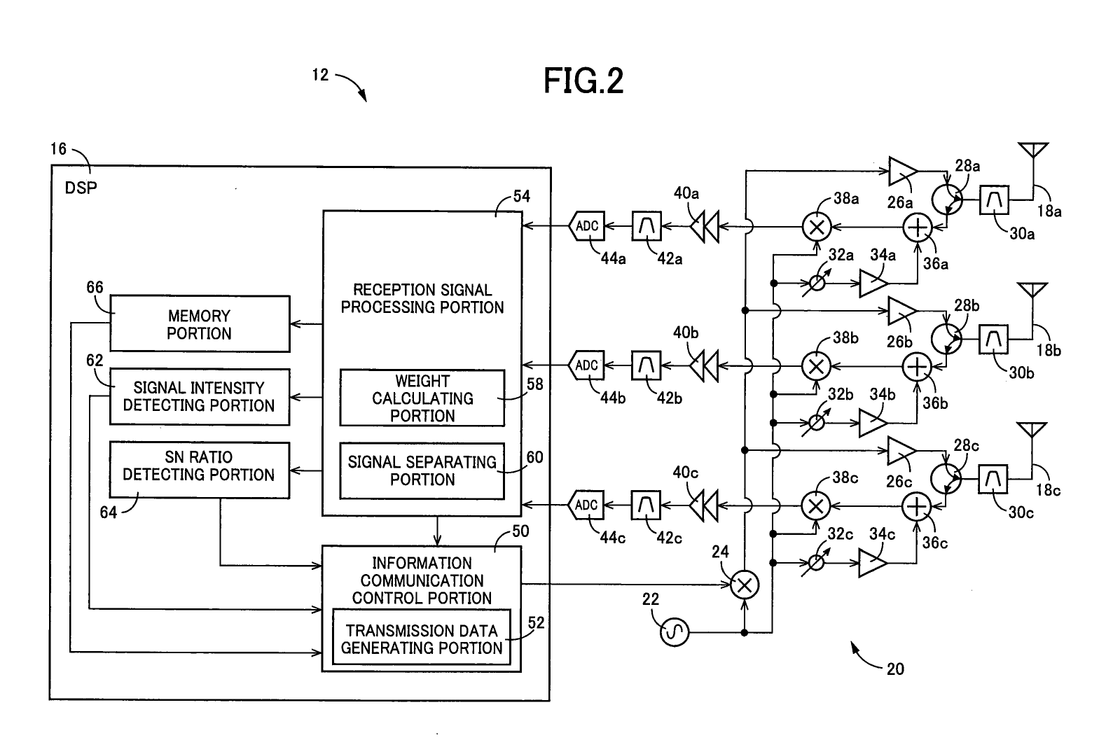

As depicted in FIG. 2, the RFID tag communicating apparatus 12 of the embodiment communicates information to read/write information from/to the RFID tags 14 and to detect directions, etc., of the RFID tags 14 and is made up of a DSP (Digital Signal Processor) 16 that executes digital signal processes such as outputting transmission data as a digital signal and reading response data from the RFID tag 14 based on a return signal from the RFID tag 14, a plurality of (in FIG. 2, three) antennas 18a, 18b, 18c (hereinafter, simply referred to as antennas 18 if not particularly distinguished) used for both the transmission of the interrogation wave F_{c} and the reception of the response wave Fᵣ, and a transmitting/receiving circuit 20 that executes a transmission process for transmitting the interrogation wave F_{c} from at least one antenna 18 of a plurality of the antennas 18 and that executes a reception process for a received signal received with a plurality of the antennas 18.

The transmitting/receiving circuit 20 includes a carrier wave output portion 22 that outputs a predetermined frequency signal corresponding to the carrier wave of the interrogation wave F_{c}; a transmission data multiplying portion 24 that multiplies the frequency signal output from the carrier wave output portion 22 by transmission data supplied from the DSP 16; a plurality of (in FIG. 2, three) transmission amplifying portions 26a, 26b, 26c that amplify the signal output from the transmission data multiplying portion 24 correspondingly to the antennas 18 (hereinafter, the transmission amplifying portions 26a, 26b, 26c are simply referred to as transmission amplifying portions 26 if not particularly distinguished); a plurality of (in FIG. 2, three) transmission/reception separating portions 28a, 28b, 28c that supply the signal output from the transmission amplifying portions 26 to the antennas 18 and that supply the received signals received by the antennas 18 to cancel combining portions 36 (hereinafter, the transmission/reception separating portions 28a, 28b, 28c are simply referred to as transmission/reception separating portions 28 if not particularly distinguished); a plurality of (in FIG. 2, three) filters 30a, 30b, 30c provided in signal transfer paths between the transmission/reception separating portions 28 and the antennas 18 (hereinafter, the filters 30a, 30b, 30c are simply referred to as filters 30 if not particularly distinguished); a plurality of (in FIG. 2, three) cancel phase sifting portions 32a, 32b, 32c that control the phase of the frequency signal output from the carrier wave output portion 22 correspondingly to the antennas 18 (hereinafter, the cancel phase sifting portions 32a, 32b, 32c are simply referred to as cancel phase sifting portions 32 if not particularly distinguished); a plurality of (in FIG. 2, three) cancel amplifying portions 34a, 34b, 34c that amplify the signals output from the cancel phase sifting portions 32 (hereinafter, the cancel amplifying portions 34a, 34b, 34c are simply referred to as cancel amplifying portions 34 if not particularly distinguished); a plurality of (in FIG. 2, three) cancel combining portions 36a, 36b, 36c that combines the cancel signals output from the cancel amplifying portions 34 with the received signals received by the antennas 18 and supplied through the filters 30 and the transmission/reception separating portions 28 (hereinafter, the cancel combining portions 36a, 36b, 36c are simply referred to as the cancel combining portions 36 if not particularly distinguished); a plurality of (in FIG. 2, three) demodulating portions 38a, 38b, 38c that multiply the signals output from the cancel combining portions 36 by the frequency signal output from the carrier wave output portion 22 to perform demodulation (hereinafter, the demodulating portions 38a, 38b, 38c are simply referred to as demodulating portions 38 if not particularly distinguished); a plurality of (in FIG. 2, three) reception amplifying portions 40a, 40b, 40c that amplify the signals output from the demodulating portions 38 (hereinafter, the reception amplifying portions 40a, 40b, 40c are simply referred to as reception amplifying portions 40 if not particularly distinguished); a plurality of (in FIG. 2, three) reception filters 42a, 42b, 42c that allow passage of signals in a predetermined frequency bands only among the signals output from the reception amplifying portions 40 (hereinafter, the reception filters 42a, 42b, 42c are simply referred to as reception filters 42 if not particularly distinguished); and a plurality of (in FIG. 2, three) reception A/D converting portions 44a, 44b, 44c that convert and supply the signals output from the reception filters 42 into digital signals to the DSP 16 (hereinafter, the reception A/D converting portions 44a, 44b, 44c are simply referred to as reception A/D converting portions 44 if not particularly distinguished).

The DSP 16 is a so-called microcomputer made up of CPU, ROM, RAM, etc., to execute signal processes in accordance with programs preliminarily stored in the ROM while utilizing a temporary storage function of the RAM and includes an information communication control portion 50, a received signal processing portion 54, a signal intensity detecting portion 62, and an SN ratio detecting portion 64 as control functions for performing the information communication control with the RFID tags 14, the direction detection control for the RFID tags 14, etc. These control functions will be described later with reference to FIGS. 4 to 16. The DSP 16 includes a memory portion 66 for storing information related to the process of received signals by the received signal processing portion 54.

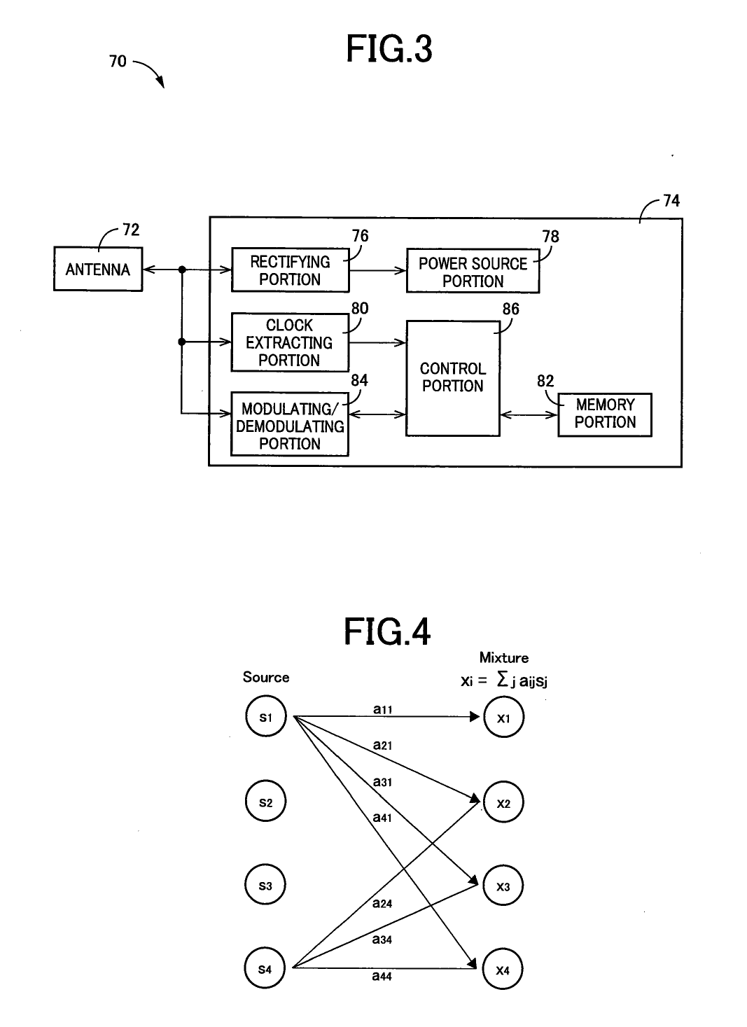

As depicted in FIG. 3, an RFID tag circuit element 70 includes an antenna portion 72 for transmitting/receiving signals to/from the RFID tag communicating apparatus 12 and an IC circuit portion 74 connected to the antenna portion 72 to execute an information communication process with the RFID tag communicating apparatus 12. The IC circuit portion 74 functionally includes a rectifying portion 76 that rectifies the interrogation wave F, received by the antenna portion 72 from the RFID tag communicating apparatus 12, a power source portion 78 for accumulating the energy of the interrogation wave F, rectified by the rectifying portion 76, a clock extracting portion 80 that extracts and supplies a clock signal from the carrier wave received by the antenna portion 72 to a control portion 86, a memory portion 82 that acts as an information storage portion that may store predetermined information signals, a modulating/demodulating portion 84 connected to the antenna portion 72 to modulate and demodulate signals, and the control portion 86 for controlling the operation of the RFID tag circuit element 70 through the rectifying portion 76, the clock extracting portion 80, the modulating/demodulating portion 84, etc. The control portion 86 performs basic controls such as control for storing the predetermined information into the memory portion 82 by performing communication with the RFID tag communicating apparatus 12 and control for demodulating and reflecting/returning the interrogation wave F_{c} received by the antenna portion 72 based on the information signal stored in the memory portion 82 as the response wave Fᵣ from the antenna portion 72 by the modulating/demodulating portion 84.

Returning to FIG. 2, the information communication control portion 50 included in the DSP 16 of the RFID tag communicating apparatus 12 controls the communication of information with the RFID tags 14 by the RFID tag communicating apparatus 12. Specifically, the information communication control portion 50 controls a transmission signal transmitted to the RFID tag 14 that is the communication object. To perform such control of the transmission signal, the information communication control portion 50 includes a transmission data generating portion 52. The transmission data generating portion 52 generates, for example, a predetermined bit string (transmission bit string) as transmission data to the RFID tag 14 and encodes and supplies the generated bit string with the FSK mode, etc., to the transmission data multiplying portion 24. The transmission data generated by the transmission data generating portion 52 is carried by the carrier wave output from the carrier wave output portion 22 from the transmission data multiplying portion 24 and is transmitted as a transmission signal through the transmission amplifying portion 26, the transmission/reception separating portion 28, and the filter 30 to the RFID tag 14 from the antennas 18.

The received signal processing portion 54 processes the received signal received with a plurality of the antennas 18 to read the response data from the RFID tag 14. Specifically, the signal supplied from the reception A/D converting portion 44 is decoded in the FSK mode, etc., and the decoded signal is interpreted to read the information signal (response data) related to the demodulation of the RFID tag 14. The received signal processing portion 54 executes a signal separation process of separating the return signals from a plurality of RFID tags 14 included in the received signal based on the received signal received with a plurality of the antennas 18 in accordance with a predefined relationship. To execute the signal separation process, the weight calculating portion 58 and the signal separating portion 60 are included. An example will hereinafter be described for a specific method of the signal separation process by the weight calculating portion 58 and the signal separating portion 60.

The signal separating portion 60 applies an appropriate weight (load) calculated by the weight calculating portion 58 to cause interference to separate a return signal from each of the RFID tags 14 from collision signals received by a plurality of the antennas 18, i.e., received signals including a mixture of the return signals from a plurality of the RFID tags 14. Assuming that x, s, A, and y denote a received signal of each antenna, a signal of each tag, a channel matrix, and an estimated output signal, a relationship represented by the following Eq. (1) is satisfied. Determining an appropriate weight is equivalent to determining W satisfying y=s when only x is known. One method for determining such an appropriate weight includes is a method using an independent component analysis (ICA) algorithm that separates signals with attention focused on the independence of signal. In this embodiment, the ICA algorithm is used for determining the appropriate weight. The ICA algorithm breaks down a probability variable into a linear combination of statistically independent variables as represented by Eq. (2). In this equation, ζ=(ζ₁, ζ₂, . . . ζₙ)^{T}, ζⱼ, and α=(α₁ⱼ, α₂ⱼ, . . . , α_{Mj})^{T} denote a probability variable vector, an independent variable, and a combination coefficient vector, respectively. Eq. (2) is hereinafter referred to as a basic ICA model and the relationship thereof is depicted in FIG. 4. The statistical independence is defined as follows and if the combination probability density function p_{12 . . . M} of the probability variables ζⱼ is representable by the product of the marginal probability density function pᵢ as represented by Eq. (3), the probability variables ζⱼ are independent of each other.

y(t)=Wx(t)=Was(t) (1)

ζ(t)=α₁ζ₁(t)+α₂ζ₂(t)+ . . . +α_{M}ζ_{M}(t) (2)

p(ζ₁, ζ₂ . . . ζ_{M})=p₁(ζ₁)p₂(ζ₂) . . . p_{M}(ζ_{M}) (3)

Many ICA algorithms determine a combination coefficient wᵢ that forms the linear combination yⱼ of the probability variables wᵢ with the highest independence from each other. The following Eq. (4) represents yⱼ. In this equation, y=(y₁, y₂ . . . y_{N})^{T} denotes an estimation vector and wᵢ=(w₁ᵢ, w₂ᵢ . . . w_{Mi})^{T} denotes a restoring vector. Except the order and the variance, yⱼ acquired from Eq. (4) is identical to sⱼ. When a matrix representative of the arbitrary property is denoted by Q, a relationship of y=Qs is satisfied. The operation of maximizing the statistic independence of yⱼ requires a reference for measuring the independence. In the central limit theorem of the statistical theory, the density distribution of probability variables consisting of a mixture of a multiplicity of independent components comes closer to the Gaussian distribution as the number of the independent components increases. Therefore, an amount for determining how far the distribution of yⱼ is away from the Gaussian distribution is preferable as a reference for measuring the independence. Negentropy closely related to information entropy is often used as a reference for determining how far certain probability variable distribution is away from the Gaussian distribution. The following Eq. (5) represents the negentropy of complex probability variable. In this equation, J(x), xgauss, and H(x)=−∫px(y)log px(y)dy denote negentropy for the probability variable x, arbitrary probability variable indicative of the Gaussian distribution, and entropy for the probability variable x, respectively. Negentropy is always nonnegative and indicates zero if the probability variable distribution is sufficiently close to the Gaussian distribution.

y(t)=w₁x₁(t)+w₁x₁(t)+ . . . +w_{N}x_{N}(t) (4)

J(x)=H(xgauss)−H(x) (5)

Many ICA algorithm determine the restoring vector wⱼ by using a gradient method and a fixed point method defining an independence reference as a cost function. A complex value using negentropy, fast ICA is the most common technique (see E. Bingham and A. Hyvarinen, “A fast fixed-point algorithm for independent component analysis of complex-valued signals,” Int. J. of Neural Systems, 10(1):1-8, 2000). Generally describing the algorithm, first, z is calculated which is a whitened observation signal x at a first calculating step. At a second calculating step, after a restoring matrix W=(w₁, w₂ . . . w_{M})^{T} is initialized by a random number element, the eigenvalue expansion is performed for orthogonalization. At a third calculation step, the following fourth and fifth calculating steps are repeated until SW, i.e., a variation of the restoring matrix is sufficiently reduced. At a fourth calculating step, the following Eq. (6) is updated with W. At this point, g(x)=tan h(x) and g′(x)=1+tan h(x) are satisfied. At a fifth calculating step, the updated W is normalized and orthogonalized. As above, the restoring vector wⱼ is determined by the first to fifth calculating steps. The estimation vector y may be represented by the following Eq. (7) with a matrix product of a complex conjugate transpose matrix W^{H} and a whitened observation signal z.

W←E{z(W^{H}z)*g(|W^{H}z|²)}−E{g(|W^{H}z|²)+|W^{H}z|²g′(|W^{H}z|²)} (6)

y(t)=W^{H}z(t) (7)

The blind signal separation is an issue of estimating source signals only from results xᵢ observed at a plurality of points mixed by different mixing coefficients in an environment receiving the arrival of signals sⱼ emitted from a multiplicity of signal sources. If the source signals are statically independent of each other, this issue basically comes down to an ICA model and, therefore, the source signals may be estimated by processing the observed signals with the independent component analysis. As above, the received signal processing portion 54 determines the resolving matrix W defined based on a whitened signal such that the elements of the estimated output signal y becomes statistically independent of each other to separate return signals s from a plurality of the RFID tags 14 as independent components included in the received signal as the observation result x. In other words, the independence is evaluated for a plurality of received signals x at least partially overlapping in both the frequency domain and the time domain and the return signals s from a plurality of the RFID tags 14 included in the received signals x are separated based on the evaluation result. A weight calculated by the weight calculating portion 58 in the signal separation process is stored in the memory portion 66. The received signal processing portion 54 may perform preliminary signal processes such as Fourier transformation and wavelet transform and adjustment such as optimization of a cost function, in addition to the method described above.

In the received signal process of this embodiment described in detail above, independent components may be separated up to the number same as the antennas 18 included in the RFID tag communicating apparatus 12. The RFID tag communicating apparatus 12 of this embodiment may perform communication in parallel with the RFID tags 14 up to the same number as the antennas 18 included in the RFID tag communicating apparatus 12. To acquire accurate output signals with the orthogonality of the signals ensured, it may be conceivable that the communication may be performed in parallel with the RFID tags 14 up to the number reduced by one from the number of the antennas 18 included in the RFID tag communicating apparatus 12.

Returning to FIG. 2, the signal intensity detecting portion 62 detects the signal intensities of the return signals from the RFID tags 14 separated by the received signal processing portion 54. The SN ratio detecting portion 64 detects the SN ratios (signal-to-noise ratios) of the return signals from the RFID tags 14 separated by the received signal processing portion 54. The signal intensities and the SN ratios of the return signals corresponding to the RFID tags 14 detected by the signal intensity detecting portion 62 and the SN ratio detecting portion 64 are supplied to the information communication control portion 50, and the information communication control portion 50 controls transmission data to be output from the transmission data generating portion 52 based on the signal intensities and/or the SN ratios of the return signals corresponding to the RFID tags 14 such that the next communication is performed with at least one RFID tag 14 of a plurality of the RFID tags 14 corresponding to the return signals separated by the received signal processing portion 54. The information communication control for a plurality of the RFID tags 14 by the information communication control portion 50 will hereinafter be described in detail.

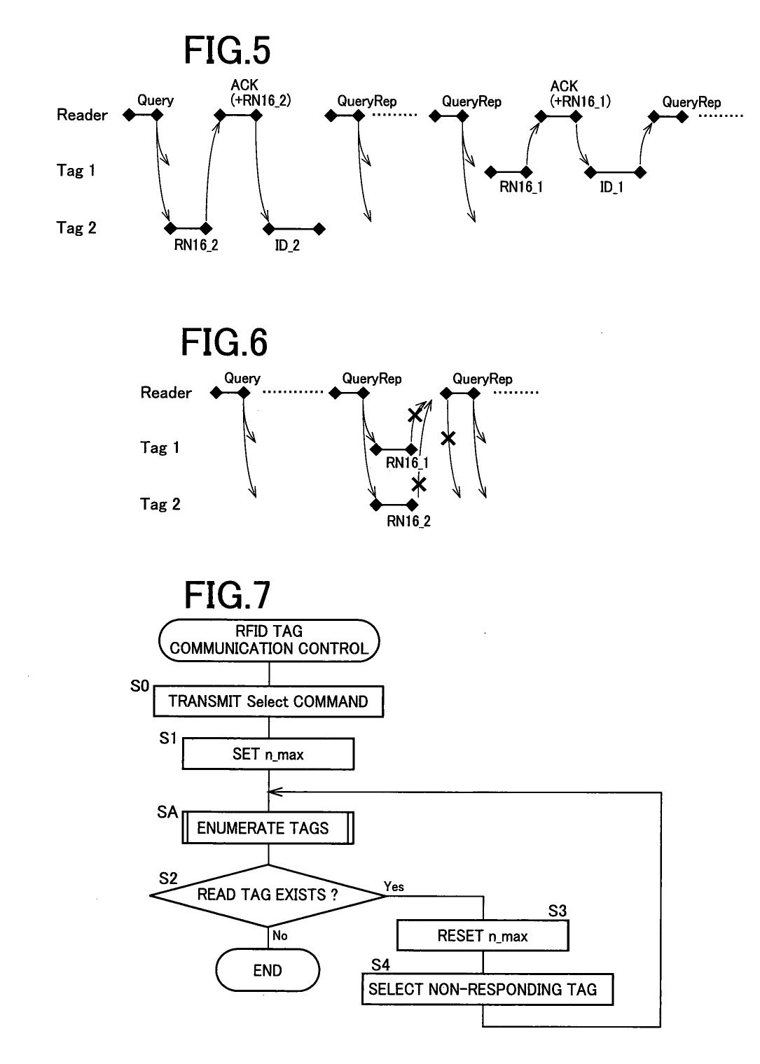

In an example depicted in FIG. 5, first, a “Query” command is transmitted from the RFID tag communicating apparatus 12 (reader). In the RFID tag 14 of the communication object, a slot number for giving a reply and a random variable “RN16” as a reply signal are determined at this timing. If a second RFID tag 14 (hereinafter, Tag2) has a slot number “0”, “RN16_2” is returned in response to the “Query” command. When RFID tag communicating apparatus 12 receives “RN16_2”, “RN16_2” is used to transmit “ACK(+RN16_2)” command for reading ID from the RFID tag communicating apparatus 12 to the Tag2. When the Tag2 receives the “ACK(+RN16_2)” command, “ID_2” corresponding to ID is returned from the Tag2 in response to the “ACK(+RN16_2)” command. The RFID tag communicating apparatus 12 transmits a “QueryRep” command at the completion of the reception of the return data and the next slot is started. If “RN16” does not returned for the “QueryRep” command during a certain time period, the “QueryRep” command is sent again to make a shift to the next slot. If a response “RN16_1” is returned from a first RFID tag 14 (hereinafter, Tag1) at a slot number “n” in response to the “QueryRep” command, “RN16_1” is used to transmit “ACK(+RN16_1)” command for reading ID from the RFID tag communicating apparatus 12 to the Tag1. When the Tag1 receives the “ACK(+RN16_1)” command, “ID_1” corresponding to ID and an error detecting signal is returned from the Tag1 in response to the “ACK(+RN16_1)” command. In the RFID tag communicating apparatus 12, a “QueryRep” command is transmitted from the RFID tag communicating apparatus 12 at the completion of the reception of the return data. If no overlap occurs in the responses from the RFID tags 14 in the time domain, the information communications are sequentially performed with the RFID tags 14 by using the number of slots determined as above.

In an example depicted in FIG. 6, the Tag1 and the Tag2 return the return signals corresponding to “RN16_1” and “RN16_2” in the same time domain in response to the “Query” command transmitted from the RFID tag communicating apparatus 12. If the responses from a plurality of the RFID tags 14 are performed in parallel (at the same time) in conventional techniques, a reader is unable to separate the received signal having a mixture of the return signals from a plurality of the RFID tags 14 into the return signals, information becomes unreadable since crosstalk occurs. Since this prevents an “ACK” command to be transmitted, both “ID_1” and “ID_2”, i.e., the IDs of the Tag1 and the Tag2 are unable to be read and the RFID tags 14 are unable to complete the responses through determined slots and therefore unable to make responses until the next “Query” command.

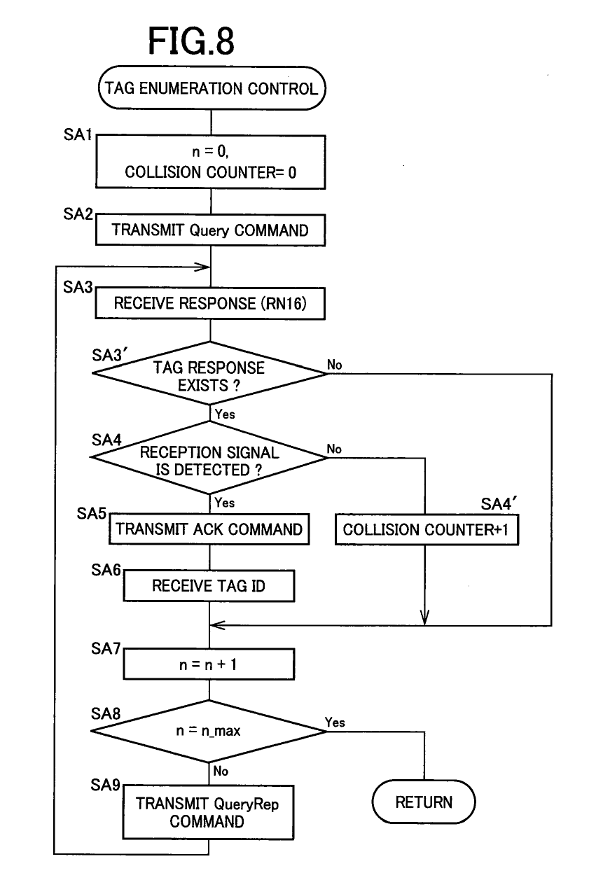

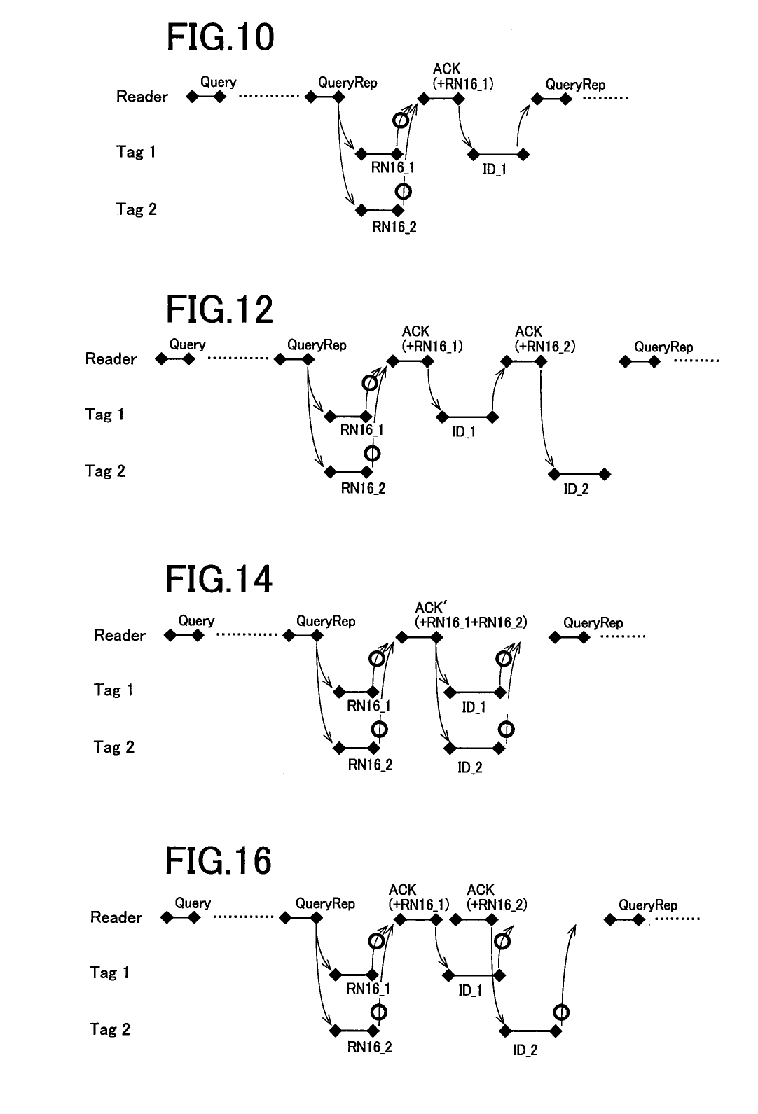

A flowchart of FIG. 7 is repeatedly executed at predetermined intervals. First, at step (hereinafter, step is omitted) S0, a “Select” command is transmitted to select a tag defined as the communication object. At S1, n_max corresponding to the maximum value of the number of slots is set. At SA, the tag enumeration control as depicted in FIG. 10 (corresponding to FIG. 8 of conventional techniques) described later is performed. At S2, it is determined whether a read tag i.e., the RFID tag 14 defined as the communication object is detected. If the determination at S2 is positive, n_max corresponding to the maximum value of the number of slots is reset (updated) at S3 and a “Select” command is transmitted at S4 to select a tag with an uncompleted response to execute the process from SA again and, if the determination at S2 is negative, this terminates the routine. Although n_max=2^{Q} is preferably set such that 2^{Q} comes closer to the number of collision slots (unable to be read due to overlap of responses) in this control, if multiple read is available for m slots as described later, the setting may be performed such that 2n_max/m comes closer to the number of collision slots.

In the control described in FIG. 8, first, at SA1, n corresponding to the number of slots and a collision counter for counting the number of collision slots are set to zero. At SA2, a “Query” command is transmitted. At SA3, a reception process is executed for a return signal (RN16) returned from the predetermined RFID tag 14 in response to the transmission signal transmitted at SA2. At SA3′, it is determined whether a response is made from the tag. If the determination at SA3′ is negative, a process from SA7 is executed and if the determination at SA3′ is positive, it is determined at SA4 whether the received signal is detected as 16-bit data. If the determination at SA4 is negative, after the value of the collision counter is increased by one at SA4′, the process from SA7 is executed, and if the determination at SA4 is positive, an “ACK” command is transmitted in response to the received signal at SA5. At SA6, a reception process is executed for a return signal (tag ID) returned from the predetermined RFID tag 14 in response to the transmission signal transmitted at SA5. At SA7, n corresponding to the number of slots is incremented by one. At SA8, it is determined whether n is n_max. If the determination at SA8 is negative, after a “QueryRep” command is transmitted at SA9, the process from SA3 is executed, and if the determination at SA8 is positive, this causes returning to the RFID tag communication control depicted in FIG. 7.

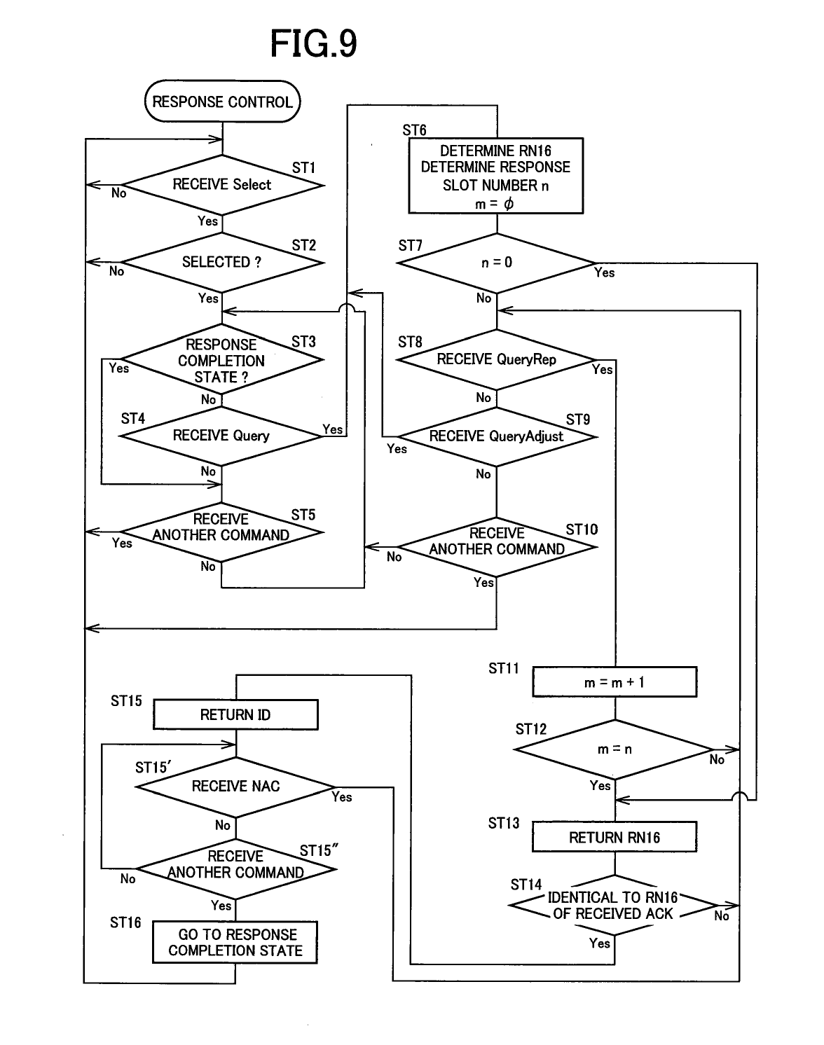

In the control described in FIG. 9, first, at ST1, it is determined whether a “Select” command is received. While the determination at ST1 is negative, the process is kept waiting by repeating the determination at ST1 and, if the determination at ST1 is positive, it is determined at ST2 whether the received “Select” command selects the receiving tag. If the determination at ST2 is negative, the process from ST1 is executed again and, if the determination at ST2 is positive, it is determined at ST3 whether a response completion state is achieved. If the determination at ST3 is positive, the process from ST5 is executed and, if the determination at ST3 is negative, it is determined at ST4 whether a “Query” command is received. If the determination at ST4 is positive, the process from ST6 is executed and, if the determination at ST4 is negative, it is determined at ST5 whether a received signal is received correspondingly to another command, i.e., a command other than the “Select” command and the “Query” command. If the determination at ST5 is positive, the process from ST1 is executed again and, if the determination at ST5 is negative, the process from ST3 is executed again.

At ST6, RN16 and the response slot number n are determined and the current slot number m is set to zero. At ST7, it is determined whether n is zero. If the determination at ST7 is positive, the process from ST13 is executed and, if the determination at ST7 is negative, it is determined at ST8 whether a “QueryRep” command is received. If the determination at ST8 is positive, the process from ST11 is executed and, if the determination at ST8 is negative, it is determined at ST9 whether a “QueryAdjust” command is received. If the determination at ST9 is positive, the process from ST6 is executed and, if the determination at ST9 is negative, it is determined at ST10 whether a received signal is received correspondingly to another command, i.e., a command other than the “QueryRep” command and the “QueryAdjust” command. If the determination at ST 10 is negative, the process from ST3 is executed again and, if the determination at ST10 is positive, the process from ST1 is executed again.

At ST11, m is increased by one. At ST12, it is determined whether m is equivalent to n. If the determination at ST12 is positive, the process from ST8 is executed again and, if the determination at ST12 is negative, a return signal corresponding to RN16 is generated and returned at ST13. At ST14, it is determined whether RN16 of the received “ACK” command is identical. If the determination at ST14 is negative, the process from ST8 is executed again and, if the determination at ST14 is positive, ID of the tag is started to be returned at ST15. At ST15′, it is detected whether a “NAK” command is received and, if this is positive, the process goes to ST8 since the response of the tag ID is not completed, and if this is negative, the process goes to ST15″ to determine whether a command other than the “NAK” command is received. If the determination at ST15″ is negative, the process from ST15′ is executed again and, if the determination at ST15″ is positive, after a shift is made to the response completion state at ST16, and the process from ST1 is executed again. When a shift is made to the response completion state at ST16, if it is determined at ST4 that the “Query” command is received, a shift to ST6 is not made. If the “ACK” command is received from the RFID tag communicating apparatus 12 and ID is returned, the RFID tag 14 halts the communication with the RFID tag communicating apparatus 12 until another predetermined command is newly received.

As depicted in FIG. 10, if overlap occurs in the responses from, a plurality of the RFID tags 14 in response to a predetermined transmission signal in a first communication, the information communication control portion 50 preferably performs a second communication with any single RFID tag 14 of a plurality of the RFID tags 14 corresponding to the return signals separated by the received signal processing portion 54. In other words, if a plurality of the RFID tags 14 makes responses in parallel in the first communication, the communication of information is continued with any one RFID tag 14 (Tag1 of FIG. 10) of a plurality of the RFID tags 14 in the second communication continued from the first communication. This enables information to be read from the predetermined RFID tag 14 of a plurality of the RFID tags 14 making responses in parallel to reduce the number of slots for the “Query command” at the time of the next communication. The information communication control portion 50 preferably performs the second communication with any single RFID tag 14 selected based on the signal intensity detected by the signal intensity detecting portion 62 among a plurality of the RFID tags 14 corresponding to the return signals separated by the received signal processing portion 54. The second communication is also preferably performed with any single RFID tag 14 selected based on the SN ratio detected by the SN ratio detecting portion 64 among a plurality of the RFID tags 14 corresponding to the return signals separated by the received signal processing portion 54. By performing control such that the second communication continued from the first communication is performed with one RFID tag 14 of a plurality of the RFID tags 14 corresponding to the return signals separated by the received signal processing portion 54, the slots may be prepared by the number of times of reading of a plurality of the RFID tags 14 and the time required for the communication may be reduced.

In the description of control of FIG. 11, steps common to the control depicted in FIG. 8 are denoted by the same reference numerals and will not be described. In this control, if the tag response is detected in the process at SA3′, a weight is calculated at SA10 for separating a received signal including a mixture of return signals from a plurality of the RFID tags 14 into signals corresponding to the individual RFID tags 14. After the received signal including a mixture of the return signals from a plurality of the RFID tags 14 is separated into the signals corresponding to the individual RFID tags 14 at SA11 based on the weight calculated at SA10, it is determined at SA11′ whether responses are detected from a plurality of tags. If the determination at SA11' is negative, the process from SA14 is executed for the one received RFID tag 14, and if the determination at SA11′ is positive, after the collision counter is increased by one at SA4′, the signal intensities and/or the SN ratios of the return signals corresponding to the RFID tags 14 separated at SA11 are detected at SAl2 corresponding to the operations of the signal intensity detecting portion 62 and the SN ratio detecting portion 64. At SA13, the RFID tag 14 is selected as the next communication object based on the signal intensities and/or the SN ratios detected at SAl2. At SA14, transmission data corresponding to the “ACK” command is generated for the RFID tag 14 selected at SA13 and is transmitted as a transmission signal from the antenna 18 through the transmission data multiplying portion 24, the transmission amplifying portion 26, etc. After the reception process is executed at SA15 for the return signal returned from the RFID tag 14 in response to the transmission signal transmitted at SA14, the process from SA7 is executed. If the determination at SA8 is positive, i.e., if it is determined that n is equivalent to n_max, this causes returning to the RFID tag communication control depicted in FIG. 7. In this process, SA1 to SA4, SA7 to SA9, and SA13 to SA16 correspond to the operation of the information communication control portion 50, and SA10 and SA11′ correspond to the operation of the received signal processing portion 54.

Since this embodiment includes the received signal processing portion 54 (SA10 and SA11) that separates the return signals from a plurality of RFID tags 14 included in the received signal based on the received signal received from a plurality of the antennas 18 correspondingly to the first communication in accordance with a predefined relationship and the information communication control portion 50 (SA1 to SA4, SA7 to SA9, and SA13 to SA16) that performs the second communication continued from the first communication with at least one RFID tag 14 of a plurality of the RFID tags 14 corresponding to the return signals separated by the received signal processing portion 54, even if a plurality of the RFID tags 14 makes responses in parallel in the first communication, the information communication may be continued in a preferable manner with a plurality of the RFID tags 14 in the second communication continued from the first communication. The RFID tag communicating apparatus 12 and the RFID tag communication system 10 may be provided that may perform the information communication in parallel with a plurality of the RFID tags 14.

Since the received signal processing portion 54 evaluates the independence of a plurality of received signal components at least partially overlapping in both the frequency domain and the time domain and separates the return signals from a plurality of the RFID tags 14 included in the received signal based on the evaluation result, the received signal having a mixture of the return signals from a plurality of the RFID tags 14 at least partially overlapping in both the frequency domain and the time domain may be separated into the components.

Since the information communication control portion 50 performs the second communication with any single RFID tag 14 of a plurality of the RFID tags 14 corresponding to the return signals separated by the received signal processing portion 54, if the responses from a plurality of the RFID tags 14 are made in parallel in the first communication, the information communication may be continued with any one RFID tag 14 of a plurality of the RFID tags 14 in the second communication continued from the first communication to prevent the occurrence of crosstalk in a preferable manner.

Since the signal intensity detecting portion 62 (SAl2) detecting the signal intensities of the return signals separated by the received signal processing portion 54 is included and the information communication control portion 50 performs the second communication with any single RFID tag 14 selected based on the signal intensity detected by the signal intensity detecting portion 62 among a plurality of the RFID tags 14 corresponding to the return signals separated by the received signal processing portion 54, if the responses from a plurality of the RFID tags 14 are made in parallel in the first communication, the information communication may be continued with any one RFID tag 14 selected based on the signal intensity among a plurality of the RFID tags 14 in the second communication continued from the first communication to prevent the occurrence of crosstalk in a preferable manner.

Since the SN ratio detecting portion 64 (SAl2) detecting the SN ratios of the return signals separated by the received signal processing portion 54 is included and the information communication control portion 50 performs the second communication with any single RFID tag 14 selected based on the SN ratio detected by the SN ratio detecting portion 64 among a plurality of the RFID tags 14 corresponding to the return signals separated by the received signal processing portion 54, if the responses from a plurality of the RFID tags 14 are made in parallel in the first communication, the information communication may be continued with any one RFID tag 14 selected based on the SN ratio among a plurality of the RFID tags 14 in the second communication continued from the first communication to prevent the occurrence of crosstalk in a preferable manner.

Since the received signal processing portion 54 whitens the received signals received by the plurality of the antennas 18 correspondingly to the first communication and normalizes and orthogonalizes the restoring matrix X determined based on the whitened signals to separate the return signals from a plurality of the RFID tags 14 as independent components included in the received signals, the return signals from a plurality of the RFID tags 14 included in the received signals received by the plurality of the antennas 18 may be separated in a practical aspect.

Since the RFID tags 14 halt communication with the RFID tag communicating apparatus 12 until another predetermined command is newly received if a predetermined command is received from the RFID tag communicating apparatus 12, crosstalk may be prevented in a preferable manner from occurring due to the responses from a plurality of the RFID tags 14 made in parallel.

Since the RFID tag communicating apparatus 12 is capable of separating signals from the RFID tags 14 up to the number same as the antennas 18 included in the RFID tag communicating apparatus 12, the return signals from a plurality of the RFID tags 14 included in the received signals received by the plurality of the antennas 18 may be separated in a preferable manner by the received signal processing portion 54 and the information communication may be performed in parallel with the largest number of the RFID tags 14.

Since the RFID tag communicating apparatus 12 is capable of separating signals from the RFID tags 14 up to the number reduced by one from the number of the antennas 18 included in the RFID tag communicating apparatus 12, the return signals from a plurality of the RFID tags 14 included in the received signals received by the plurality of the antennas 18 may be separated in a preferable manner by the received signal processing portion 54 and, if responses are made from the RFID tags 14 of the number equal to or greater than that of the plurality of the antennas 18, an error in the weight may be detected and the information communication may be performed in parallel with a plurality of the RFID tags 14.

Another aspect of the process by the RFID tag communicating apparatus 12 of this embodiment will then be described for the case of the responses from the RFID tags 14 overlapping in both the frequency domain and the time domain. As depicted in FIG. 12, if overlap occurs in both the frequency domain and the time domain in the responses from a plurality of the RFID tags 14 in response to a predetermined transmission signal in the first communication, the information communication control portion 50 of this embodiment sequentially performs the second communication with a plurality of the RFID tags 14 corresponding to the return signals separated by the received signal processing portion 54. In an example depicted in FIG. 12, if the Tag1 and the Tag2 return the return signals corresponding to “RN16_1” and “RN16_2” in response to the “QueryRep” command, the “ACK(+RN16_1)” command for reading ID is first transmitted to the Tag1 to perform communication for reading ID from the Tag1 and the “ACK(+RN16_2)” command for reading ID is then transmitted to the Tag2 to perform communication for reading ID from the Tag2. This enables the number of slots to be reduced at the time of the retransmission of the “Query” command by sequentially performing the communication with a plurality of the RFID tags 14 making responses in parallel and the time required for the control of enumerating a plurality of the RFID tags 14 may be reduced.

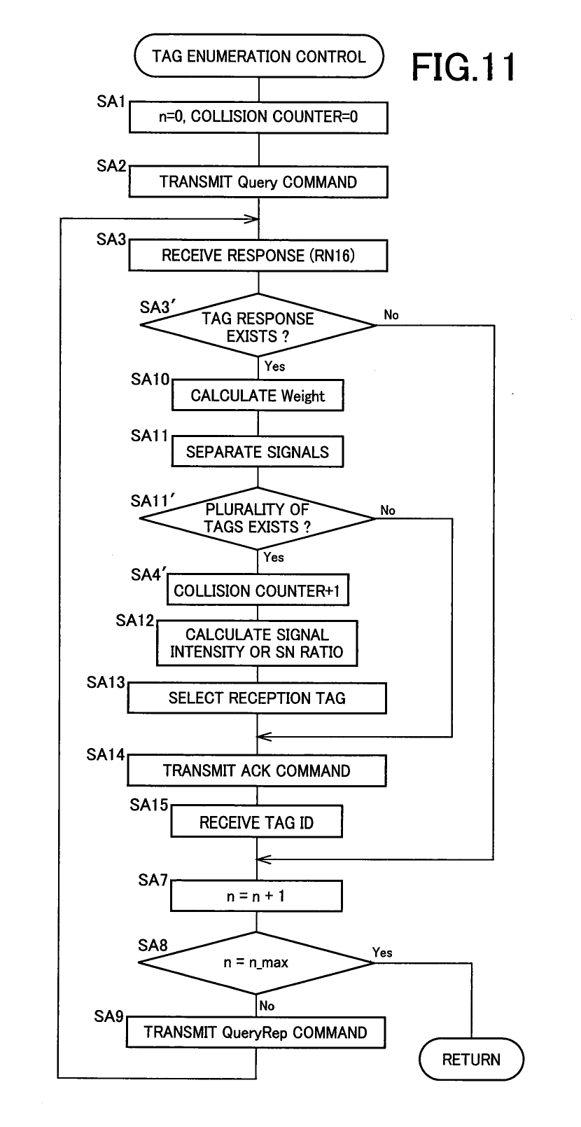

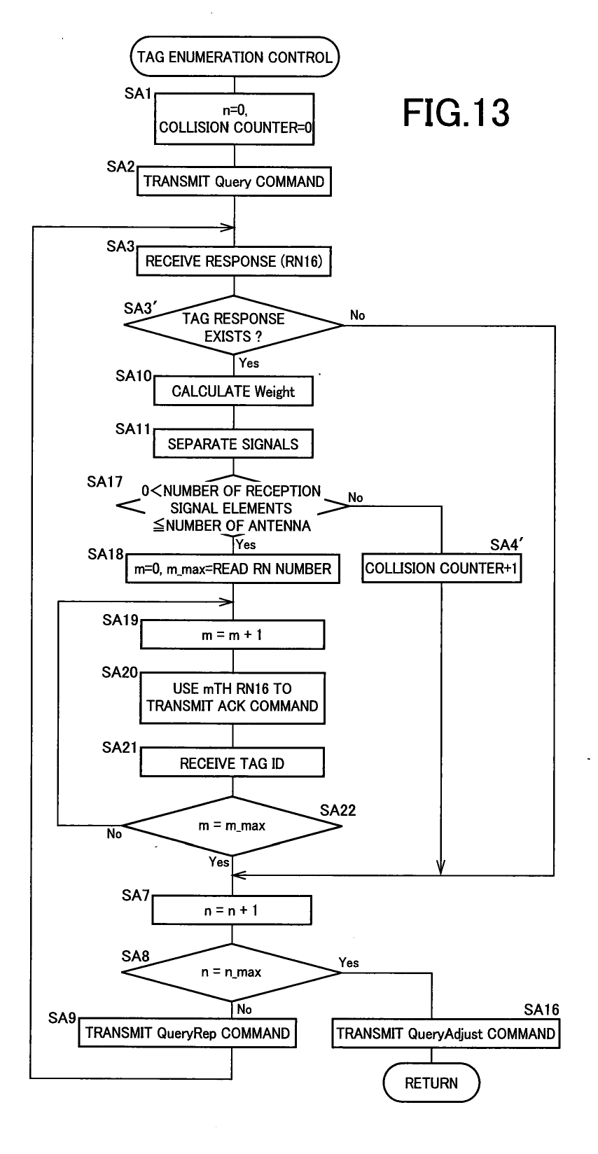

In the description of control of FIG. 13, steps common to the control depicted in FIGS. 8 and 11 are denoted by the same reference numerals and will not be described. In this control, after the process at SA11, it is determined at SA17 whether the number of received signal components separated at SA11 falls within a range greater than zero and equal to or less than the total number of the antennas 18. If the determination at SA17 is negative, after the process at SA4′ is executed, the process from SA7 is executed and if the determination at SA17 is positive, m is set to zero at SA18 and m_max is set to the read RN number. At SA19, m is increased by one. At SA20, mth RN16 is used to generate transmission data corresponding to the “ACK” command and the transmission data is transmitted as a transmission signal from the antenna 18 through the transmission data multiplying portion 24, the transmission amplifying portion 26, etc. At SA21, the reception process is executed for the return signal returned from the RFID tag 14 in response to the transmission signal transmitted at SA20. At SA22, it is determined whether m is equivalent to m_max. If the determination at SA22 is negative, the process from SA19 is executed again and if the determination at SA22 is positive, the process from SA7 is executed. In the control, SA1 to SA3, SA7 to SA9, and SA16 to SA22 correspond to the operation of the information communication control portion 50.

According to this embodiment, since the information communication control portion 50 (SA1 to SA3, SA7 to SA9, and SA16 to SA22) sequentially performs the second communication with a plurality of the RFID tags 14 corresponding to the return signals separated by the received signal processing portion 54, even if a plurality of the RFID tags 14 makes responses in parallel in the first communication, the information communication may sequentially be continued with a plurality of the RFID tags 14 in the second communication continued from the first communication.

As depicted in FIG. 14, if overlap occurs in both the frequency domain and the time domain in the responses from a plurality of the RFID tags 14 in response to a predetermined transmission signal in the first communication, the information communication control portion 50 of this embodiment performs the second communication at the same time with a plurality of the RFID tags 14 corresponding to the return signals separated by the received signal processing portion 54 and, based on received signals received by the plurality of the antennas 18 correspondingly to the second communication, the received signal processing portion 54 separates the return signals from a plurality of the RFID tags 14 included in the received signals. A weight is preferably stored in the memory portion 66 as a calculation result of the process of separating the return signals from a plurality of the RFID tags 14 included in received signals received by the plurality of the antennas 18 correspondingly to the first communication, and the weight stored in the memory portion 66 is read and used for the signal separation in the second communication. In an example depicted in FIG. 14, if the Tag1 and the Tag2 return the return signals corresponding to “RN16_1” and “RN16_2” in response to the “QueryRep” command, an “ACK(+RN16_1+RN16_2)” command for concurrently reading IDs is transmitted to the Tag1 and the Tag2. The return signals returned from the Tag1 and the Tag2 in response to the “ACK(+RN16_1+RN16_2)” command are received in the same time domain, and the return signal corresponding to the Tag1 and the return signal corresponding to the Tag2 are separated from the received signal. This enables communication to be performed at the same time with a plurality of the RFID tags 14 making responses in parallel and enables IDs of a plurality of the RFID tags 14 to be read at the same time up to the limit of the readable number. This enables reducing an initial number of slots and the number of slots at the time of the retransmission of the “Query” command and the time required for the control of enumerating a plurality of the RFD) tags 14 may expeditiously be reduced.

For the weight used for receiving the responses from a plurality of tags in the case of using the method, a weight calculated at the time of reception of the responses to the “Query” command may be retained in the memory portion 66 and the weight may be read and used when the responses to the “ACK(+RN16_1+RN16_2)” command are received and processed. By reusing the weight as above, a calculation amount in the weight calculating portion 58 may be reduced.

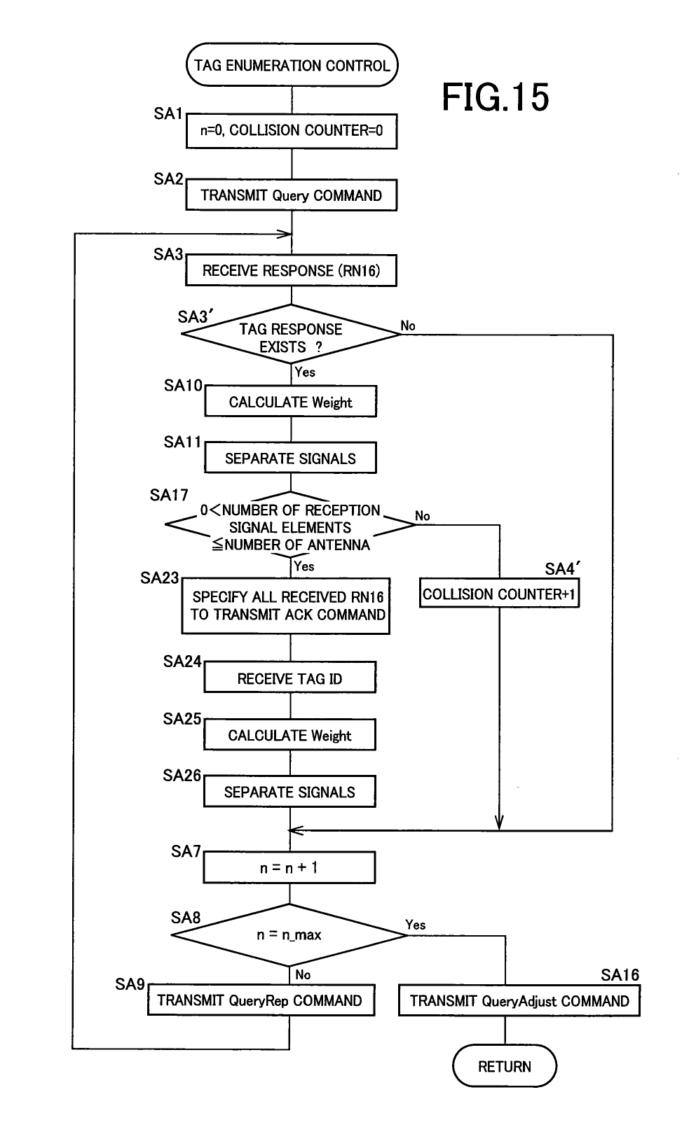

In the description of control of FIG. 15, steps common to the control depicted in FIG. 8, etc., are denoted by the same reference numerals and will not be described. In this control, if the determination at SA 17 is positive, i.e., if it is determined that the number of received signal components separated at SA11 falls within a range greater than zero and equal to or less than the total number of the antennas 18, all RN16 included in the received signals are specified to generate transmission data corresponding to the “ACK” command and the transmission data is transmitted as a transmission signal from the antenna 18 through the transmission data multiplying portion 24, the transmission amplifying portion 26, etc., at SA23. At SA24, the reception process is executed for the return signal returned from the RFID tag 14 in response to the transmission signal transmitted at SA23. A weight is calculated at SA25 for separating the received signal including a mixture of return signals from a plurality of the RFID tags 14 into signals corresponding to the individual RFID tags 14. If the weight stored in the memory portion 66 is read and utilized, this step of SA25 is skipped. After the received signal including a mixture of the return signals from a plurality of the RFID tags 14 is separated into the signals corresponding to the individual RFID tags 14 at SA26 based on the weight calculated (or read from the memory portion 66) at SA25, the process from SA7 is executed. In this process, SA1 to SA3, SA7 to SA9, SA16, SA17, SA23, and SA24 correspond to the operation of the information communication control portion 50, and SA10, SA11, SA25, and SA26 correspond to the operation of the received signal processing portion 54.

According to this embodiment, since the information communication control portion 50 (SA1 to SA3, SA7 to SA9, SA16, SA17, SA23, and SA24) performs the second communication at the same time with a plurality of the RFID tags 14 corresponding to the return signals separated by the received signal processing portion 54 and, based on received signals received by the plurality of the antennas 18 correspondingly to the second communication, the received signal processing portion 54 separates the return signals from a plurality of the RFID tags 14 included in the received signals, even if a plurality of the RFID tags 14 makes responses in parallel in the first communication, the information communication may be continued at the same time with a plurality of the RFID tags 14 in the second communication continued from the first communication.

Since the information communication control portion 50 utilizes the calculation result of the process of separating the return signals from a plurality of the RFID tags 14 included in received signals received by the plurality of the antennas 18 correspondingly to the first communication at the time of the process of separating the return signals from a plurality of the RFID tags 14 included in the received signals received by the plurality of the antennas 18 correspondingly to the second communication, if the information communication is continued at the same time with a plurality of the RFID tags 14 in the second communication continued from the first communication, the received signals corresponding to the second communication may expeditiously be separated in a short period of time into the return signals from the RFID tags 14.

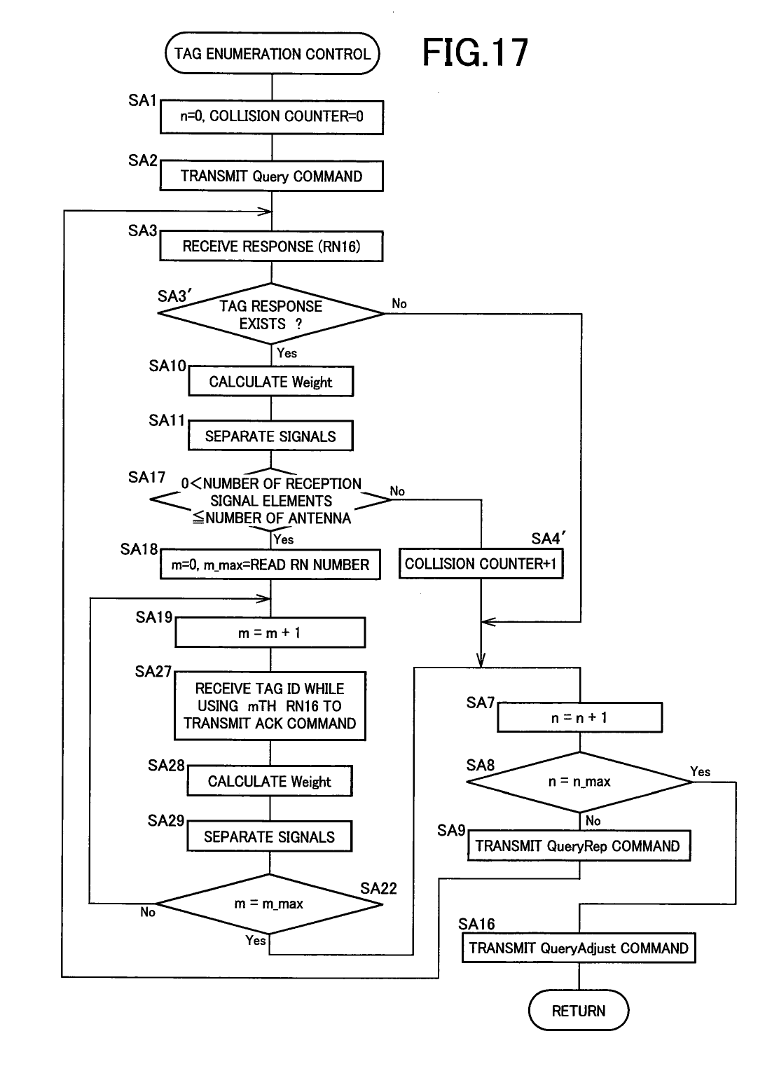

As depicted in FIG. 16, when sequentially performing the second communication with a plurality of the RFID tags 14 corresponding to the return signals separated by the received signal processing portion 54, the information communication control portion 50 of this embodiment transmits the transmission signals to the other RFID tag 14 while receiving the return signal from the predetermined RFID tag 14. In an example depicted in FIG. 16, the “ACK(+RN16_1)” command for reading ID is first transmitted to the Tag1 to perform communication for reading ID from the Tag1 and the “ACK(+RN16_2)” command for reading ID is transmitted to the Tag2 during the reception of the return signal corresponding to ID from the Tag 1 to perform communication for reading ID from the Tag2. This enables communication to be sequentially performed in parallel with a plurality of the RFID tag 14 making responses in parallel and enables IDs of a plurality of the RFID tags 14 to be read at the same time up to the limit of the readable number. This enables the initial number of slots as well as the number of slots at the time of the retransmission of the “Query” command to be reduced and the time required for the control of enumerating a plurality of the RFID tags 14 may be reduced. If overlap occurs in the time domain between the transmission of the transmission signal and the returning of the return signals from the RFID tags 14, the waveform of the transmission signal is known and therefore may be determined or separated by the received signal processing portion 54.

In the description of control of FIG. 17, steps common to the control depicted in FIG. 8, etc., are denoted by the same reference numerals and will not be described. In this control, at SA27 after the process at SA19, mth RN16 is used to generate transmission data corresponding to the “ACK” command and the transmission data is transmitted as a transmission signal from the antenna 18 through the transmission data multiplying portion 24, the transmission amplifying portion 26, etc., and the reception process is executed for the return signal returned from the RFID tag 14 in response to the transmitted transmission signal. A weight is calculated at SA28 for separating the received signal including a mixture of return signals from a plurality of the RFID tags 14 into signals corresponding to the individual RFID tags 14. If the weight stored in the memory portion 66 is read and utilized, this step of SA28 is skipped. After the received signal including a mixture of the return signals from a plurality of the RFID tags 14 is separated into the signals corresponding to the individual RFID tags 14 at SA29 based on the weight calculated (or read from the memory portion 66) at SA28, the process from SA22 is executed. In this process, SA1 to SA3, SA7 to SA9, SA16 to SA19, and SA27 correspond to the operation of the information communication control portion 50, and SA10, SA11, SA28, and SA29 correspond to the operation of the received signal processing portion 54.

According to this embodiment, when sequentially performing the second communication with a plurality of the RFID tags 14 corresponding to the return signals separated by the received signal processing portion 54, the information communication control portion 50 of this embodiment transmits the transmission signals to the other RFID tag 14 while receiving the return signal from the predetermined RFID tag 14 and, therefore, even if a plurality of the RFID tags 14 makes responses in parallel in the first communication, the information communication may sequentially and expeditiously be continued in a short period of time with a plurality of the RFID tags 14 in the second communication continued from the first communication.

Although the preferred embodiments of the present invention have been described in detail with reference to the drawings, the present invention is not limited to this description and is implemented in other aspects.

For example, although the control functions such as the information communication control portion 50, the received signal processing portion 54, the signal intensity detecting portion 62, and the SN ratio detecting portion 64 are functionally included in the DSP 16 of the RFID tag communicating apparatus 12 in the embodiments, this is not a limitation of the present invention and the control devices having these control functions may individually be provided. The control by these control functions may be performed regardless of whether digital signal processes or analog signal processes.

Although the RFID tag communicating apparatus 12 includes a plurality of the antennas 18 used for both transmission and reception in the embodiments, one or a plurality of antennas for transmitting the transmission signals may separately be included. The number of the antennas 18 is changed as needed in accordance with design, and the maximum number of the RFID tags 14 separable by the received signal processing portion 54 is determined depending on the number of the antennas 18 as described above.

Although the RFID tag communicating apparatus 12 does not control the directionality in either the transmission of the transmission signals and the reception of the received signals in the embodiments, it may be conceivable that the transmission directionality or the reception directionality of an array antenna consisting of the antennas 18 may be controlled by providing a phase shifter, etc.

Although the RFID tag communicating apparatus 12 includes the cancel phase sifting portion 32, the cancel amplifying portion 34, the cancel combining portion 36, etc., as a configuration for constraining a sneak signal from the transmission side in the embodiments, these constituent elements are not necessarily be provided if the effect of the sneak signal from the transmission side is negligibly small.

Although not exemplary illustrated one by one, the present invention is implemented with various modifications within a range not departing from the spirit thereof.

1. An RFID tag communicating apparatus transmitting a transmission signal to a predetermined RFID tag and receiving a return signal returned from the RFID tag with a plurality of antennas to communicate information with the RFID tag, comprising:
a received signal processing portion that separates return signals from a plurality of RFID tags included in received signals based on the received signals received with the plurality of the antennas correspondingly to a first communication in accordance with a predefined relationship; and
an information communication control portion that performs a second communication continued from the first communication with at least one RFID tag of a plurality of the RFID tags corresponding to the return signals separated by the received signal processing portion.

2. The RFID tag communicating apparatus of claim 1, wherein the received signal processing portion evaluates independency of a plurality of received signal components at least partially overlapping in both a frequency domain and a time domain to separate return signals from a plurality of RFID tags included in the received signals based on the evaluation result.

3. The RFID tag communicating apparatus of claim 1, wherein the information communication control portion performs the second communication with any single RFID tag of a plurality of the RFID tags corresponding to the return signals separated by the received signal processing portion.

4. The RFID tag communicating apparatus of claim 3, comprising a signal intensity detecting portion that detects signal intensities of the return signals separated by the received signal processing portion, wherein the information communication control portion performs the second communication with any single RFID tag selected based on the signal intensities detected by the signal intensity detecting portion from a plurality of the RFID tags corresponding to the return signals separated by the received signal processing portion.

5. The RFID tag communicating apparatus of claim 3, comprising an SN ratio detecting portion that detects SN ratios of the return signals separated by the received signal processing portion, wherein the information communication control portion performs the second communication with any single RFID tag selected based on the SN ratios detected by the SN ratio detecting portion from a plurality of the RFID tags corresponding to the return signals separated by the received signal processing portion.

6. The RFID tag communicating apparatus of claim 1, wherein the information communication control portion sequentially performs the second communication with a plurality of the RFID tags corresponding to the return signals separated by the received signal processing portion.

7. The RFID tag communicating apparatus of claim 6, wherein when the second communication is sequentially performed with a plurality of the RFID tags corresponding to the return signals separated by the received signal processing portion, the information communication control portion transmits a transmission signal to another RFID tag while receiving a return signal from a predetermined RFID tag.

8. The RFID tag communicating apparatus of claim 1, wherein the information communication control portion performs the second communication at the same time with a plurality of the RFID tags corresponding to the return signals separated by the received signal processing portion and wherein based on received signals received by the plurality of the antennas correspondingly to the second communication, the received signal processing portion separates return signals from a plurality of the RFID tags included in the received signals.

9. The RFID tag communicating apparatus of claim 8, wherein at the time of process of separating the return signals from a plurality of the RFID tags included in the received signals received by the plurality of the antennas correspondingly to the second communication, the received signal processing portion utilizes a calculation result of a process of separating the return signals from a plurality of the RFID tags included in the received signals received by the plurality of the antennas correspondingly to the first communication.

10. The RFID tag communicating apparatus of claim 1, wherein the received signal processing portion whitens the received signals received by the plurality of the antennas correspondingly to the first communication and normalizes and orthogonalizes a restoring matrix determined based on the whitened signals to separate the return signals from a plurality of the RFID tags as independent components included in the received signals.

11. An RFID tag communication system communicating information among a plurality of RFID tags and the RFID tag communicating apparatus of claim 1.

12. The RFID tag communication system of claim 11, wherein if a predetermined command is received from the RFID tag communicating apparatus, the RFID tag halts communication with the RFID tag communicating apparatus until another predetermined command is newly received.

13. The RFID tag communication system of claim 11, wherein the RFID tag communicating apparatus communicates in parallel with the RFID tags up to number same as antennas included in the RFID tag communicating apparatus.

14. The RFID tag communication system of claim 11, wherein the RFID tag communicating apparatus communicates in parallel with the RFID tags up to number reduced by one from number of antennas included in the RFID tag communicating apparatus.
